(19) United States
(12) Patent Application Publication
(10) Pub. No.: US 2007/0262199 A1
(43) Pub. Date: Nov. 15, 2007

(54) Shelton wing in ground effect

(76) Inventor: David Barbour Shelton, Winnetka, IL (US)

Correspondence Address: David B. Shelton, 1340 Westmoor Trail, Winnetka, IL, 60093, US

(21) Appl. No.: 11/432,170

(22) Filed: May 11, 2006

(51) Int. Cl. B64C 39/12

(52) U.S. Cl. 244/45 R

(57) ABSTRACT

Wing in ground effect vehicles operate near the surface to acquire benefits in aerodynamic performance. However, a lack of sufficient stability has been a frequent limitation for such vehicles. The disclosed invention is a wing in ground effect vehicle that comprises a plurality of mechanical devices to acquire stability in roll and height with respect to the surface. Each device comprises a pivotally mounted aerodynamic lifting surface, surface contacting element, and interconnecting structure. The disclosed arrangement of these components actively determines the angle of attack of the aerodynamic lifting surfaces and produces vehicle stability in roll and height with respect to the surface.

### BACKGROUND OF THE INVENTION

The present invention pertains to the active stabilization of wing in ground effect vehicles (herein referred to as “WIG vehicles”) A WIG vehicle is a specialized aircraft that operates primarily in close proximity to the surface and extracts benefits from ground effect. Ground effect is a phenomenon that results when an aerodynamic lifting surface operates in close proximity (generally less than the vehicles wing span) to the surface. Ground effect produces benefits that include a reduction of induced drag and increased lift from ram air effects.

A leading barrier to the practical implementation of WIG vehicles has been the requirement for high stability. For the purposes of this document, stability refers to a vehicles tendency to maintain desired attitude (namely pitch and roll) and height above the surface. Conventional aircraft, which operate primarily out of ground effect, commonly acquire positive stability through passive features. A horizontal stabilizer and dihedral angle of the wings are normally employed to achieve stability in the longitudinal and lateral directions respectively. Although such methods have worked well in conventional aircraft, the resulting levels of stability are not always sufficient for WIG vehicles.

WIG vehicles require high levels of stability because the ground effect phenomenon can be destabilizing and because small deviations of attitude can result in contact with the surface. Active stability systems have demonstrated increased levels of stability. In common practice, a computer monitors the states of the vehicle via an array of electronic sensors. When instabilities are detected, the computer actively manipulates the vehicles flight controls in a corrective manner. While effective, such measures are not practical for many WIG vehicle applications.

### BRIEF SUMMARY OF THE INVENTION

The invention, herein called a SWIG vehicle, is a WIG vehicle with a plurality of mechanical active stability devices. Each device comprises a pivotally mounted aerodynamic lifting surface, a surface contacting element, and interconnecting structure. The disclosed arrangement of these components actively determines the angle of attack of the aerodynamic lifting surface in a stabilizing manner. By design, the aerodynamic lifting surface tends to maintain a steady height above the surface.

The SWIG vehicle comprises a plurality of mechanical active stability devices with at least two said devices offset laterally from a plane comprising the vehicles longitudinal and vertical axes. In such a configuration, the mechanical active stability devices contribute to the vehicles lateral stability and help the vehicle maintain a consistent height above the surface.

### DETAILED DESCRIPTION OF INVENTION

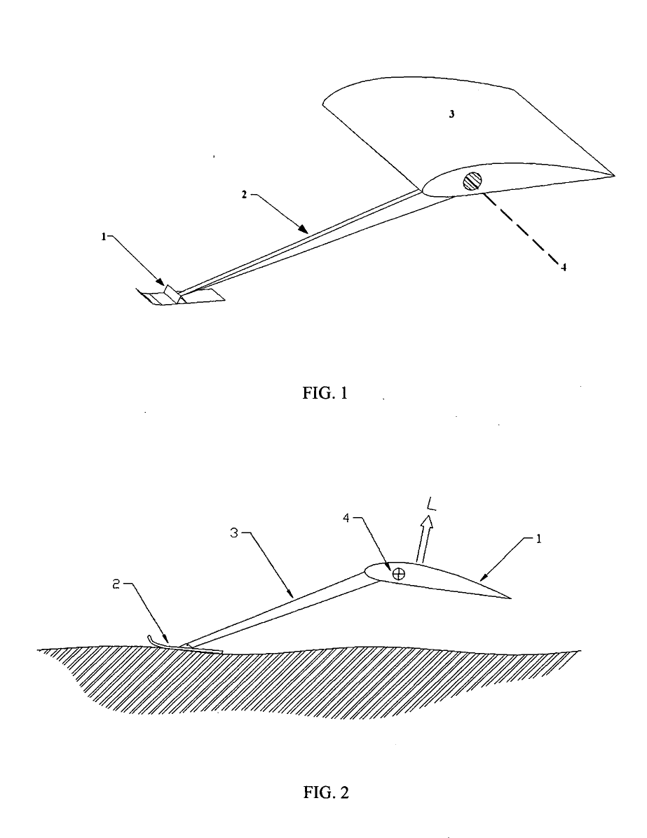

FIG. 1 depicts a typical mechanical active stability device comprising an aerodynamic lifting surface (1), surface contacting element (2) and interconnecting structure (3). Item (4) designates a generally lateral/span-wise axis about which the aerodynamic lifting surface is pivotally mounted to the WIG vehicle. The surface-contacting element is a device that can translate along the surface with little resistance. In following illustrations, the surface contacting element is depicted as a ski but it is to be understood that the surface contacting element may consist of a wheel, hydrofoil, skate, or other suitable device for operation over water, snow, ice, pavement or other surfaces.

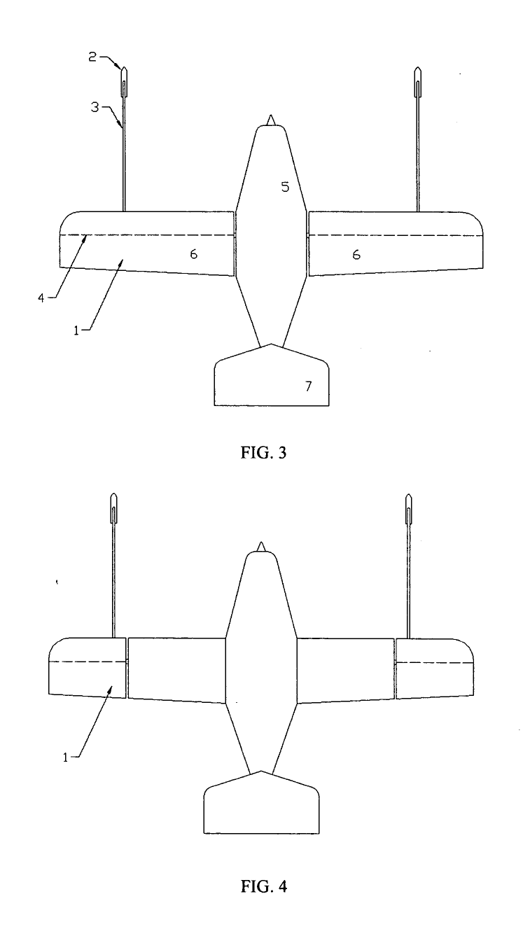

FIG. 2 depicts a mechanical active stability device of FIG. 1 in side view and comprising an aerodynamic lifting surface (1), surface contacting element (2), and interconnecting structure (3). In the disclosed invention, the aerodynamic lift (L) is shown to act at a center of pressure that is behind the axis of rotation (4), thereby inducing a negative (nose-down) pitching moment about the axis of rotation. The negative pitching moment, which is reacted by a normal force on the surface contacting element, ensures that the surface contacting element maintains contact with the surface. This arrangement is highly resistant to blow-over; an undesirable tendency for some WIG vehicles to pitch up in an uncontrollable and divergent manner.

FIG. 3 depicts a SWIG vehicle of conventional configuration comprising a body (5), wings (6), and tail surfaces (7). The lessons of this invention may also be applied to canard, tandem, biplane, flying wing and other WIG vehicle configurations. The depicted SWIG vehicle has two mechanical active stability devices; said devices offset laterally from a plane comprising the longitudinal and vertical axes; each said device comprising an aerodynamic lifting surface (1) that is pivotally mounted about a generally lateral/span-wise axis (4), surface contacting element (2), and interconnecting structure (3). In this example, each aerodynamic lifting surface is common to each wing.

FIG. 4 depicts a SWIG vehicle similar to FIG. 3 but wherein outer portions of the wings comprise the aerodynamic lifting surfaces of the mechanical active stability devices. It is to be understood that a range of configurations are possible including those wherein the aerodynamic lifting surface is separate from the wings.

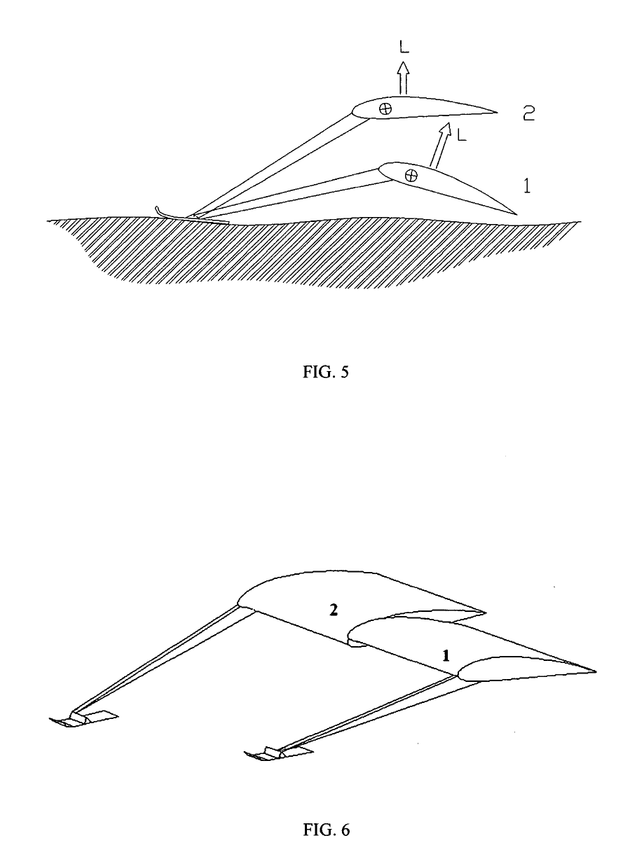

FIG. 5 illustrates SWIG stability in height. The figure depicts the mechanical active stability device of FIG. 2, with the aerodynamic lifting surface shown at various heights above the surface. The aerodynamic lifting surface, due to attachment of the connecting structure, is forced to assume a large angle of attack at lower heights (1), resulting in greater lift and a tendency to climb. The aerodynamic lifting surface is forced to assume a small angle of attack at greater heights (2), resulting in reduced lift and a tendency to descend. These actions illustrate the tendency for an active stability device to maintain a steady height above the surface. This process makes SWIG vehicles stable in height.

FIG. 6 illustrates the lateral stability of a simple SWIG vehicle. In this case the SWIG vehicle consists of two mechanical active stability devices pivotally joined to each other. The vehicle is shown in banked flight and it can be seen that the lower wing assumes a high angle of attack and the higher wing assumes a low angle of attack. The resulting imbalance of lift will restore the vehicle to wings-level flight. This process results in lateral/roll stability.

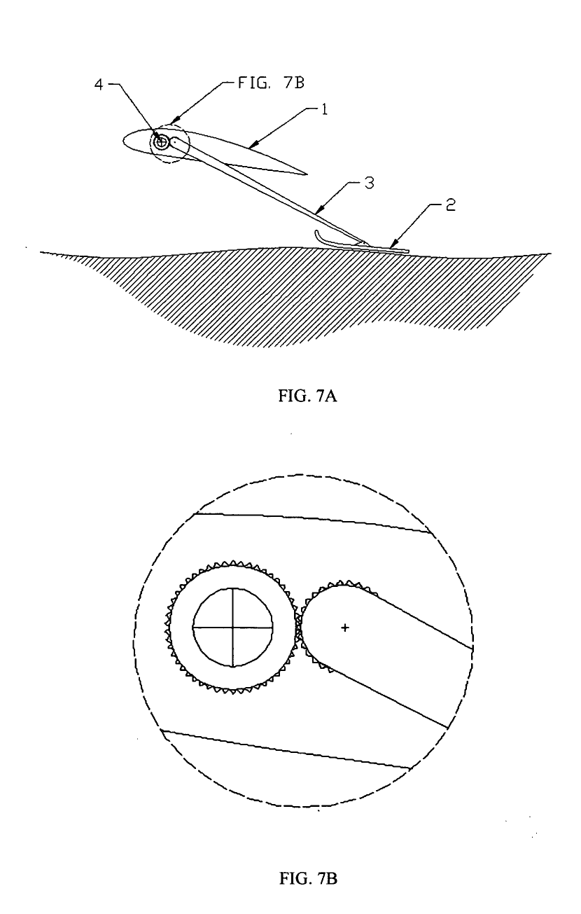

FIG. 7A demonstrates a geared connection between the interconnecting structure and the aerodynamic lifting surface. In previous examples, the interconnecting structure was rigidly fastened to the aerodynamic lifting surface. By introducing gearing, the stability effects may be amplified or reduced. Gearing also makes it possible to locate the surface-contacting element behind the aerodynamic lifting surface while still creating the desired effect; increasing the angle of attack at lower heights and reducing the angle of attack at greater heights. Gearing may be accomplished with gears, belts and pulleys, levers, hydraulics or other appropriate mechanical means.

FIG. 7B shows the gearing of FIG. 7A in greater detail.

I claim:

1. A wing in ground effect vehicle with a plurality of mechanical active stability devices; at least two said devices offset laterally from a plane comprising the longitudinal and vertical axes; said devices comprising:
a) An aerodynamic lifting surface that is pivotally mounted about a generally lateral/span-wise axis and said axis located ahead of the aerodynamic lifting surface center of pressure;
b) A surface contacting element such as a wheel, float, ski, hydrofoil or other suitable device;
c) An interconnecting structure.

2. A vehicle of claim one wherein the pivotally mounted aerodynamic lifting surface may be an entire wing, portion of said wing, or independent of said wing.

3. A vehicle of claim one that may be propelled by a propeller, sail, tow rope, or other suitable means of propulsion.

4. A vehicle of claim one that is also capable of flight outside of ground effect.

5. A vehicle of claim one wherein the aerodynamic lifting surfaces are not pivotally mounted about the lateral axis, but achieve a similar effect by twisting about their lateral axis.

6. A vehicle of claim one wherein the surface-contacting element is located ahead of the aerodynamic lifting surface and the connecting structure is rigidly connected to the aerodynamic lifting surface.

7. A vehicle of claim one wherein the connecting structure is attached to the aerodynamic lifting surface by mechanical gearing.

8. A vehicle of claim 7 wherein the mechanical gearing is achieved with gears, belts, pulleys, levers, hydraulics or other suitable means.

9. A vehicle of claim 7 wherein the surface-contacting element may be located behind the aerodynamic lifting surface.
